(19) United States
(12) Patent Application Publication
(10) Pub. No.: US 2009/0314321 A1
(43) Pub. Date: Dec. 24, 2009

(54) Polygonal Tarp for Debris Removal

(76) Inventor: John J. Van Dyken, Moorestown, NJ (US)

Correspondence Address: FOX ROTHSCHILD, LLP;Pittsburgh, 2000 Market Street, 10th Floor, Philadelphia, PA, 19103, US

(21) Appl. No.: 12/144,731

(22) Filed: Jun. 24, 2008

(51) Int. Cl. E04H 15/30

(52) U.S. Cl. 135/95

(57) ABSTRACT

A polygonal tarp, preferably octagonal in shape, having strapping handles attached at opposite ends to facilitate the pulling of debris piled on the tarp, and a plurality of lifting handled attached to said tarp along the lengthwise sides. The tarp is also provided with hooks co-located with the lifting handles to facilitate the folding of the tarp into a cup-shape by attaching each corner having a hook to another corner of the tarp.

### SUMMARY OF THE INVENTION

A polygonal tarp, preferably octagonal, is affixed with at least two main handles on each length-wise side above and below the plane defined by the tarp and a gripping handle above the plane of the tarp on either or both width-wise sides. The tarp is utilized primarily for ergonomic debris removal.

### DESCRIPTION OF THE DRAWINGS

FIG. 1 is a top view of the tarp of the present invention

FIG. 2 is a bottom view of the tarp of the present invention.

FIG. 3 is an alternate embodiment of the invention having detachable handles.

### DETAILED DESCRIPTION

According to a preferred embodiment, tarp 10 of the present invention is formed in the shape of a polygon, preferably as irregular polygon, and, more preferably, is formed having an octagonal shape. It is also preferred that tarp 10 be bilaterally symmetrical.

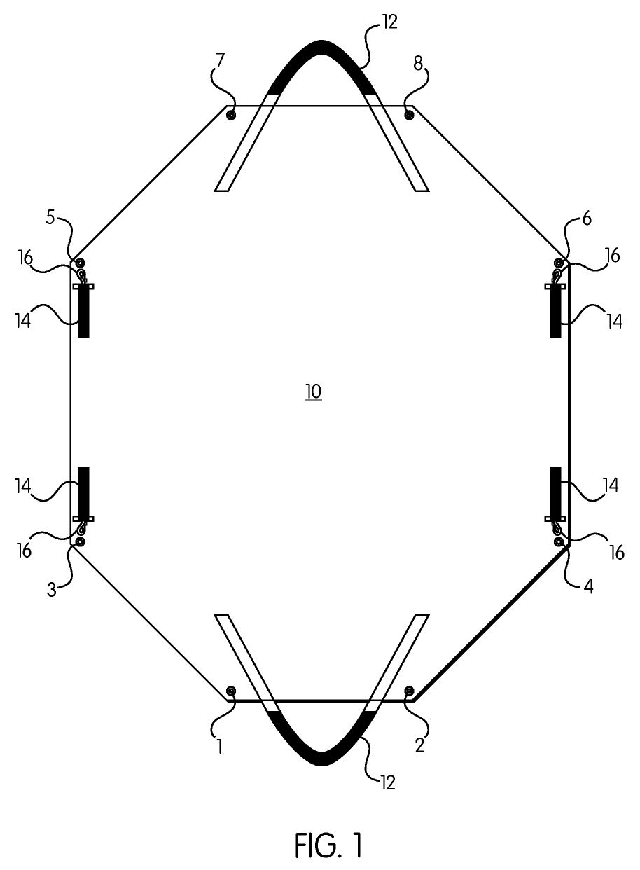

The preferred embodiment of the invention is provided with strapping handles 12 disposed at opposite ends, as shown in FIG. 1. Strapping handles 12 are preferably attached by stitching, although other means of attachment are within the scope of the invention. Additionally, strapping handles 12 may be fully or partially covered with rubber piping or other padding material for comfort and ease of handling. Preferably, strapping handles 12 are positioned such as to provide a pulling force directed along the longitudinal axis of tarp 10.

In another embodiment, multiple strapping handles 12 may be provided on each end of tarp 10, disposed on opposing sides of the longitudinal axis, such as to provide even pulling along the length of tarp 10 when pulled by one or multiple persons.

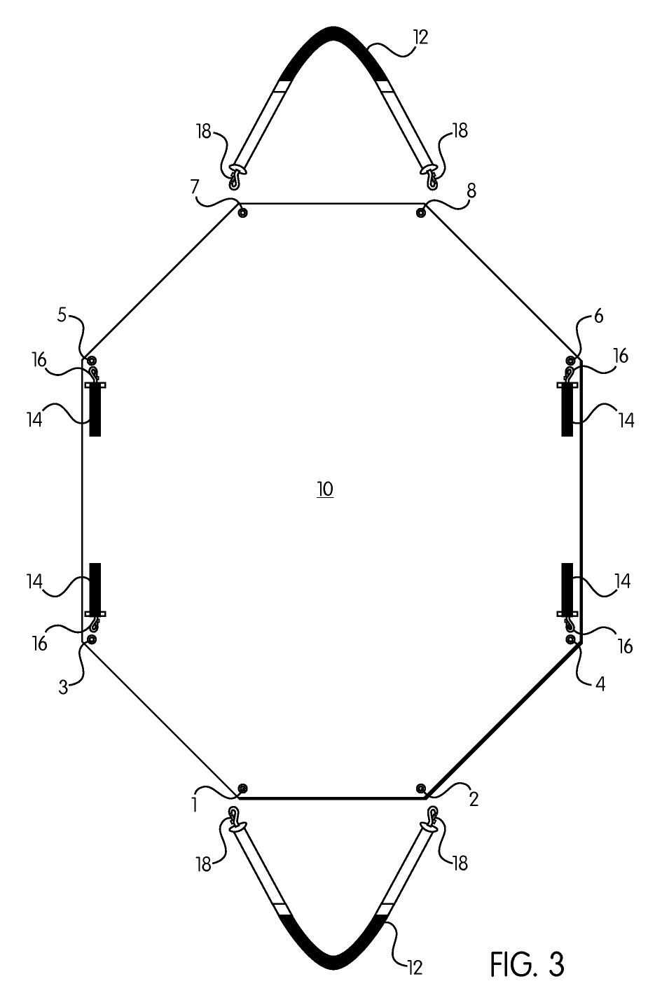

In an alternate embodiment, the strapping handles may be detachable, as shown in FIG. 3. In this embodiment, strapping handles 12 are configured with hooks 18 which allow connection to tarp 10 by engaging hooks 18 with one or more grommet holes located ion the end sides of tarp 10. Preferably, hooks 18 are snap-fish hooks, but any type of hook well known in the art may be used, such as spring clips, carabiners, and the like. Preferably, hooks 18 will be attached to one or more grommet holes, such as grommet holes 7 and 8 for one handle and grommet holes 1 and 2 for the other handle, as shown in FIG. 3. Having hooks 18 attached at grommet holes which are spread apart from each other will allow handle 12 to pull the tarp into a pocket shape when pulled upon.

In yet another embodiment, detachable handles 12 may be used with any standard tarp having an attachment means, such as grommet holes, including tarps of any shape. Consumer-grade tarps widely available in stores are typically rectangular in shape. When used with rectangular shaped tarps, hooks 18 may be engaged with multiple grommet holes to form the tarp into a pocket shape such that debris loaded onto the tarp will be contained therein.

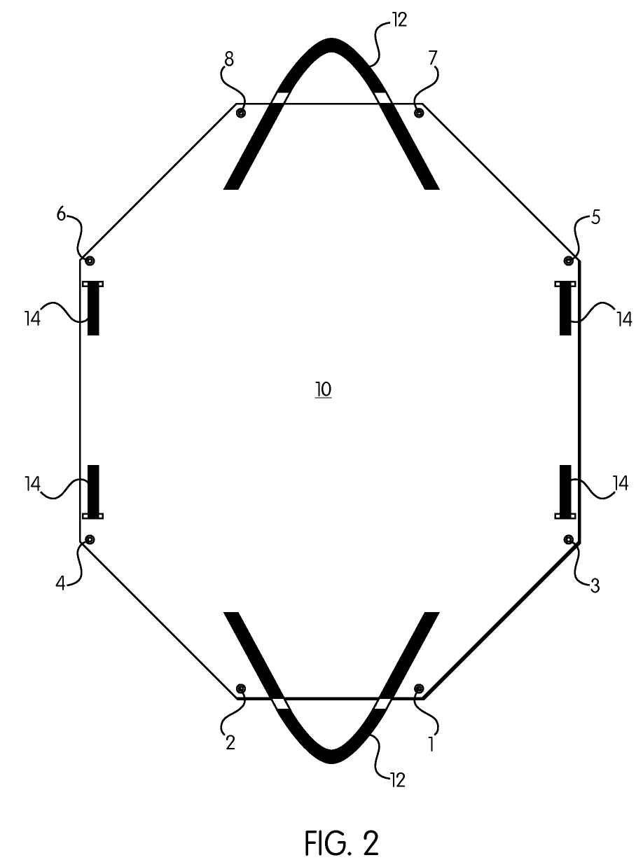

The tarp is also provided with a plurality of handles 14 disposed at various positions along the lateral edges of tarp 10. In the octagonal embodiment, there may be, for example, four handles 14 disposed near grommet holes 3, 4, 5, and 6, as shown in FIGS. 1 and 2. Each of handles 14 are preferably in the shape of hoops threaded through two reinforced slits defined in the body of tarp 10 such that half of hoop projects above the plane of tarp 10 and half projects below the plane of tarp 10, such as to allow handles 14 to be used from either side of tarp 10. Handles 14 in the form of hoops may also be sewn to tarp 10 at one end thereof and allowed to pass through a reinforced slit on the opposite side thereof, again allowing use from either side of tarp 10. Half-loop handles 14 can also be sewn or other-wise affixed opposite each other on the top side and underside of tarp 10 at each handle position, or may just be affixed to one side of tarp 10.

Handles 14 along the lateral edges of tarp 10, shown two per side in FIGS. 1 and 2, are designed to ergonomically facilitate the lifting and unloading of debris, while strapping handles 12 on opposite ends of either or both ends of the long dimension of tarp 10 are designed to ergonomically facilitate dragging rather than lifting. Strapping handles 12 are preferably dimensioned to allow room for more than one person to drag tarp 10.

Tarp 10 is suited for multiple purposes, but is primarily constructed for the removal of yard debris by piling the debris onto tarp 10 and dragging to a suitable dumping place. Such debris may include, but is not limited to, dirt, branches, leaves, stones, grass cuttings and weeds. It can also be used to haul mulch, topsoil, fertilizer, peat and other gardening and landscaping supplies, as well as firewood, wall and paving stones and other heavy loads. The ergonomic ease with which loads may be dragged allow heavier loads to be transported, thereby reducing the number of trips required to move a pile of leaves or other debris to the curb or otherwise move a quantity of heavy materials.

Tarp 10 is also preferably provided with hooks 16, shown in FIG. 1, attached to each of handles 14, which also are preferably permanently stitched to tarp 10. Hooks 16 disposed near grommet holes 3 and 4 can be hooked through grommet holes 1 and 2 respectively. Likewise, hooks 16 disposed near grommet holes 5 and 6 can be hooked through grommet holes 7 and 8 respectively. This arrangement forms tarp 10 into a pocket shape to prevent the load from falling out. Hooks 16 are preferably snap-fish hooks, but any means for attaching grommets together can be used, such as bungee cords, spring clips, carabiners, and the like. Snap fish hooks are preferably permanently sewn into handles 14 of tarp 10 to prevent them from being misplaced.

In another embodiment, additional hooks 16 (not shown) or other attachment means can be used to attach grommets 5 and 6 to grommets 3 and 4 respectively, to further define the pocket shape.

Note that it is not actually necessary for tarp 10 to be provided with grommet holes. Hooks 16 may be attached to attachment means integrated with or disposed near handles 14.

An octagonal tarp shape is particularly advantageous for pocket formation.

The octagon is formed by cutting the corners off of a square or rectangular tarp. Irregular octagons formed from a rectangle are preferred such that the tarp is provided with a length (along the longitudinal axis) dimension longer that the width dimension to maximize load capacity.

Tarp 10 can be made of durable cloth fabric, including natural fabrics such as canvas and heavy linen or synthetic fabrics such as nylon. Tarp 10 can also be formed from conventional polyolefin films typically used to make outdoor tarps. A typical tarp may have dimensions of 10′×12′, but any size is contemplated to be within the scope of the invention.

I claim:

1. A tarp comprising:
a. a polygonal sheet of flexible material having a length and a width;
b. one or more strapping handles disposed on opposite ends of the length of said tarp; and
c. a plurality of lifting handles disposed at intervals along the lengthwise edges of said tarp.

2. The tarp of claim 1 wherein said strapping handles comprise lengths of material attached at opposite ends to said tarp to form a closed loop.

3. The tarp of claim 2 wherein said strapping handles are attached to said tarp by stitching.

4. The tarp of claim 3 wherein said strapping handles are covered by a rubber tubing or other padding.

5. The tarp of claim 1 wherein each of said lifting handles comprise a hoop of material which passes through two slots defined in said sheet of flexible material.

6. The tarp of claim 1 wherein each of said lifting handles comprises a length of material attached at opposite ends to the top surface of said sheet of material.

7. The tarp of claim 6 further comprising a second length of material attached to the bottom surface of said sheet of material opposite said first length.

8. The tarp of claim 1 wherein each of said lifting handles comprises a length of material having opposite ends attached to the top and bottom of said sheet or material and further wherein said length of material passes through a slot defined in said sheet of material.

9. The tarp of claim 1 wherein said polygonal sheet is octagonal in shape.

10. The tarp of claim 9 wherein said polygonal sheet is an irregular octagon, having its length greater than its width.

11. The tarp of claim 9 wherein said lifting handles comprise two pairs of lifting handles disposed on opposite sides of the width of said tarp, at the corners furthest away from the longitudinal axis of said tarp.

12. The tarp of claim 11 further comprising a plurality of hooks attached to said sheet of material.

13. The tarp of claim 12 wherein said hooks are selected from a group consisting of snap fish hooks, bungee cords, spring clips and carabiners.

14. The tarp of claim 12 wherein said hooks are disposed in proximity to said lifting handles.

15. The tarp of claim 14 wherein said hooks are integrated with said plurality of lifting handles.

16. The tarp of claim 13 wherein each of said hooks facilitates the connection of a one corner of said tarp farthest from said longitudinal axis to a corner of said tarp nearer said longitudinal axis.

17. The tarp of claim 1 wherein said sheet of flexible material is selected from a group consisting of canvas, heavy linen, nylon or a polyolefin film.

18. The tarp of claim 1 having grommet-reinforced holes defined at various locations around the edge of said tarp, and particularly at each corner thereof.

19. A tarp comprising:
a. an octagonal sheet of flexible material having a length and a width, said sheet defining eight corners, four of said corners located farther away from the longitudinal axis of said sheet than the other four corners;
b. a plurality of lifting handles, one of said lifting handles disposed near each of said corners located farther away from the longitudinal axis of said sheet; and
c. a plurality of hooks, attached to said sheet, each of said hooks in close proximity to one of said lifting handles.

20. The tarp of claim 19 further comprising one or more strapping handles disposed on opposite ends of the length of said tarp, between two of said corners located closer to the longitudinal axis of said sheet.

21. The tarp of claim 18 wherein said strapping handles are detachable, further comprising hooks disposed at opposite ends of each of said strapping handles for engagement with one or more of said grommet holes.

22. A tarp comprising:
a. a polygonal sheet of flexible material having a length and a width, said sheet of flexible material being configured with a plurality of grommet-reinforced holes disposed at various locations around the edges of said sheet; and
b. one or more detachable strapping handles having hooks disposed at opposite ends of each of said strapping handles for engagement with one or more of said grommet-reinforced holes.
